(19) United States
(12) Patent Application Publication
(10) Pub. No.: US 2013/0332686 A1
(43) Pub. Date: Dec. 12, 2013

(54) INFORMATION PROCESSING APPARATUS, INFORMATION PROCESSING METHOD, AND PROGRAM

(71) Applicant: Sony Corporation, Tokyo (JP)

(72) Inventors: Hiroaki Ishizawa, Chiba (JP); Seiya Ichimori, Kanagawa (JP)

(73) Assignee: Sony Corporation, Tokyo (JP)

(21) Appl. No.: 13/899,627

(22) Filed: May 22, 2013

(30) Foreign Application Priority Data
Jun. 6, 2012 (JP) 2012-128770

(51) Int. Cl. G06F 3/06

(52) U.S. Cl. CPC G06F 3/0647
USPC 711/162

(57) ABSTRACT

A computer-implemented information processing method, apparatus and computer-readable storage medium comprising computer-executable instructions that, when executed by at least one processor, perform an information processing method. Configuration management information is rewritten base based on a status of a first apparatus designated to execute a process. The configuration management information defines one or more relationships between one or more virtual devices and one or more physical devices. The rewritten configuration management information is provided to the first apparatus.

### RELATED APPLICATIONS

This utility patent application claims the benefit of Japanese Priority Patent Application JP 2012-128770 filed in the Japan Patent Office on Jun. 6, 2012, which is incorporated herein by reference in its entirety.

### BACKGROUND

The present disclosure relates to an information processing apparatus, an information processing method, and a program.

Process migration is a technique used for executing a process continuously while an apparatus that executes the process is alternated. In recent years, various new techniques have been proposed for the process migration. For example, Shaya Potter et al., “Secure Isolation and Migration of Untrusted Legacy Applications”, Columbia University Technical Report CUCS-005-04 (January 2004) discloses a technique that implements a function capable of restricting system resources accessible by an application and a function capable of providing a virtual environment for isolating an application. In order to transfer an application to a virtual environment, a checkpoint/restart mechanism is used. In this regard, a checkpoint/restart mechanism is a technique where a state of a currently executing process is stored in advance and the executing state of the process is restored based on the previously stored information in the event of a failure or malfunction. Andrey Mirkin et al., “Containers checkpointing and live migration”, Proceedings of the Linux Symposium, July 2008, Vol. 2, P. 85-90 discloses a virtualization of process ID, separation of groups, separation and virtualization of network, virtualization of resource, and so on, in a technique used to migrate a process group in the unit of “container”.

However, in the case of performing a process migration between apparatus which are installed in a home, specifications of I/O devices are different for each apparatus, and thus a technique for virtualization of the I/O devices to absorb the difference is used. In such an environment, for example, there may be a case of allowing the execution of a process to be migrated to an apparatus having a higher processing capability and continuously using I/O devices which have been used in a migration source apparatus through a network. Alternatively, there may be a case of using a high functional user-friendly I/O device which is included in any other apparatus connected through a network.

In this regard, a technology for virtualization of I/O devices may include a technique where a local physical I/O device (hardware) is regarded as if it is a different device and a technique where a remote physical I/O device is regarded as if it is a local I/O device. For example, Japanese Patent Application Laid-Open Publication No. 2010-009396 discloses a technique, in a case where a virtual machine is migrated, for realizing the continuous use of physical devices at before and after the migration by delivering information which indicates the states of devices between device drivers used at before and after the migration. In addition, Japanese Patent Application Laid-Open Publication No. 2009-070135 discloses a technique for a virtual device driver itself to be migrated according to the migration of process.

### SUMMARY

However, for example, in accordance with the teachings disclosed in the above-mentioned Japanese Patent Application Laid-Open Publication No. 2010-009396, it is difficult to make continuous use of physical devices when a process is migrated, without involving migration of a virtual machine, for example, using the above-mentioned checkpoint/restart mechanism. Furthermore, in accordance with the teachings disclosed in the above-mentioned Japanese Patent Application Laid-Open Publication No. 2009-070135, it is difficult to switch between a local device and a remote device. In this way, techniques for changing the settings of physical devices used for a process migration have not yet been sufficiently proposed.

Therefore, embodiments of the present disclosure provide a novel and improved information processing apparatus, information processing method, and program, capable of easily optimizing the configuration of a physical device used by a process.

Some embodiments relate to a computer-implemented information processing method. The method may include rewriting, based on a status of a first apparatus designated to execute a process, configuration management information that defines one or more relationships between one or more virtual devices and one or more physical devices. The method may also provide the rewritten configuration management information to the first apparatus.

In some embodiments the process may be migrated from a second apparatus to the first apparatus. Rewriting the configuration management information may be performed by the first apparatus or the second apparatus.

In embodiments where the first apparatus rewrites the configuration management information, the process may be executed on the second apparatus using a physical device of the second apparatus prior to migrating the process from the second apparatus to the first apparatus. After migrating the process from the second apparatus to the first apparatus, the process may be executed on the first apparatus using a physical device of the first apparatus or the process may be executed on the first apparatus using a physical device of a third apparatus different from the first apparatus and the second apparatus. Alternatively, after migrating the process from the second apparatus to the first apparatus, executing the process on the first apparatus using a dummy device of the first apparatus.

In embodiments where the second apparatus rewrites the configuration management information, the process may be executed on the second apparatus using a physical device located in a third apparatus prior to migrating the process from the second apparatus to the first apparatus. After migrating the process from the second apparatus to the first apparatus, the process may be executed on the first apparatus using a physical device located in the second apparatus or the process may be executed on the first apparatus using a physical device located in a fourth apparatus. Alternatively, after migrating the process from the second apparatus to the first apparatus, the process may be executed on the first apparatus using a dummy device of the first apparatus.

In some embodiments, the status may include at least one processing capability of the first apparatus, at least one property of a user of the first apparatus and/or at least one property of a communication environment of the first apparatus. For example, a processing capability of the first apparatus may indicate that the first apparatus has more processing capability than the second apparatus, and a property of the user may include the user's location with respect to the first apparatus.

Some embodiments relate to at least one non-transitory computer-readable storage medium comprising computer-executable instructions that, when executed by at least one processor, perform an information processing method. The method may include rewriting, based on a status of an apparatus designated to execute a process, configuration management information that defines one or more relationships between one or more virtual devices and one or more physical devices. The method may also include providing the rewritten configuration management information to the apparatus

Some embodiments relate to an information processing apparatus. The information processing apparatus may include a rewriting device configured to rewrite, based on a status of the information processing apparatus, configuration management information that defines one or more relationships between one or more virtual devices and one or more physical devices. The information processing apparatus may also include a storage device configured to store the rewritten configuration management information. The information processing apparatus may further include a providing device configured to provide the rewritten configuration management information to the storage device.

Some embodiments relate to an information processing apparatus including a rewriting device configured to rewrite, based on a status of a first apparatus designated to that will execute a process, configuration management information that defines one or more relationships between one or more virtual devices and one or more physical devices. The information processing apparatus may also include a communication device configured to receive the status from the first apparatus, and provide the rewritten configuration management information to the first apparatus.

In accordance with the embodiments of the present disclosure described above, the configuration of physical devices used by a process can be easily optimized.

### BRIEF DESCRIPTION OF THE DRAWINGS

FIG. 1 is a diagram for explaining how to use devices at the time of the execution of a process according to a first embodiment of the present disclosure;

FIG. 2 is a diagram illustrating an overview of a process migration according to the first embodiment of the present disclosure;

FIG. 3 is a diagram for explaining how to use devices after the migration of the process is completed according to the first embodiment of the present disclosure;

FIG. 4 is a flow chart illustrating an exemplary process of the process migration according to the first embodiment of the present disclosure;

FIG. 5 is a schematic block diagram illustrating a functional configuration of a migration destination apparatus according to the first embodiment of the present disclosure;

FIG. 6 is a flow chart illustrating an exemplary process of a process migration according to a second embodiment of the present disclosure;

FIG. 7 is a schematic block diagram illustrating a functional configuration of a migration source apparatus according to the second embodiment of the present disclosure;

FIG. 8A is a diagram for explaining a specific example of rewriting configuration management information according to an embodiment of the present disclosure;

FIG. 8B is a diagram for explaining a specific example of rewriting configuration management information according to an embodiment of the present disclosure;

FIG. 8C is a diagram for explaining a specific example of rewriting configuration management information according to an embodiment of the present disclosure;

FIG. 8D is a diagram for explaining a specific example of rewriting configuration management information according to an embodiment of the present disclosure;

FIG. 8E is a diagram for explaining a specific example of rewriting configuration management information according to an embodiment of the present disclosure;

FIG. 9A is a diagram for explaining a specific example of rewriting configuration management information according to an embodiment of the present disclosure;

FIG. 9B is a diagram for explaining a specific example of rewriting configuration management information according to an embodiment of the present disclosure;

FIG. 9C is a diagram for explaining a specific example of rewriting configuration management information according to an embodiment of the present disclosure;

FIG. 9D is a diagram for explaining a specific example of rewriting configuration management information according to an embodiment of the present disclosure;

FIG. 9E is a diagram for explaining a specific example of rewriting configuration management information according to an embodiment of the present disclosure;

FIG. 9F is a diagram for explaining a specific example of rewriting configuration management information according to an embodiment of the present disclosure; and

FIG. 10 is a block diagram illustrating a hardware configuration of an information processing apparatus.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be provided in the following order.

1. First Embodiment (rewriting of migration destination device)

2. Second Embodiment (rewriting of migration source device)

3. Specific Example of Rewriting

4. Hardware Configuration

5. CONCLUSION

### 1. FIRST EMBODIMENT

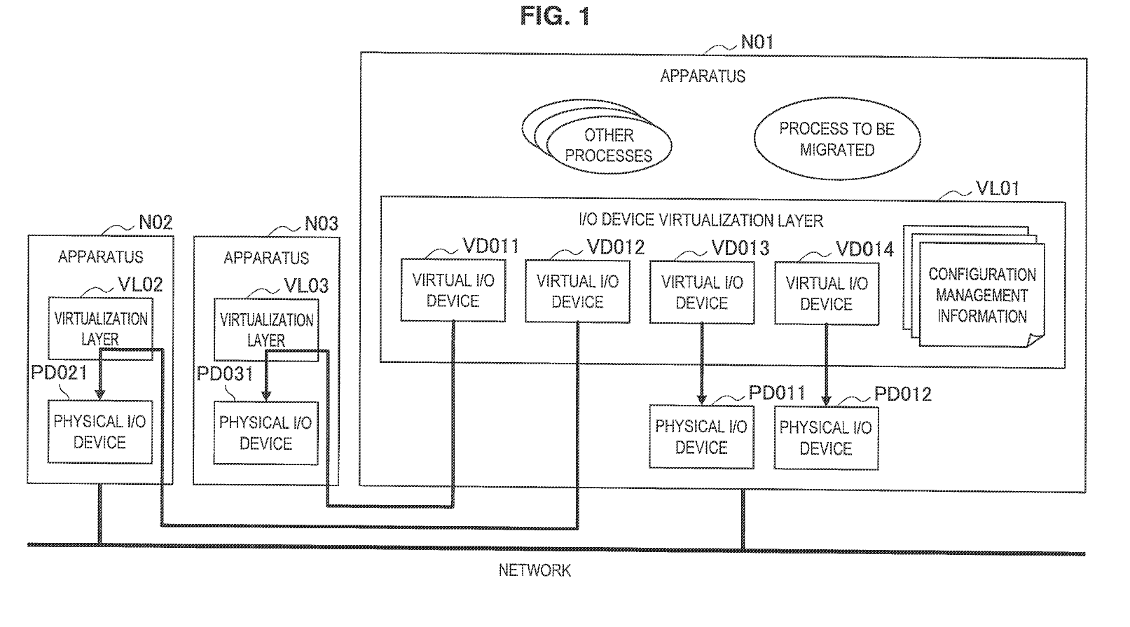

A first embodiment of the present disclosure will now be described with reference to FIGS. 1 to 5.

FIG. 1 is a diagram for explaining how to use devices at the time of the execution of a process according to the first embodiment of the present disclosure. Referring to FIG. 1, apparatus N01, N02, and N03, respectively, are provided with I/O device virtualization layers VL01, VL02, and VL03. In the following description, “I/O device” is also simply referred to as “device”.

For example, in the apparatus N01, the device virtualization layer VL01 virtualizes physical devices PD011, PD012 located locally in the apparatus N01 and physical devices PD021, PD031 located remotely from the apparatus N01. In addition, the device virtualization layer VL01 regards virtual devices VD011 to VD014 as if they are internally located in the same area. A process executed in the apparatus N01 (including a process to be migrated in the following description) uses the virtual devices VD011 to VD014 rather than directly make use of the physical devices PD011, PD012, PD021, and PD031. Thus, the local and remote physical devices can be treated as the same devices in the process.

The virtualization layer VL01 contains configuration management information used to manage corresponding relationships between the virtual devices VD011, VD012, VD013, and VD014 and the physical devices PD011, PD012, PD021, and PD031, respectively. The apparatus N01 may contain only one type of configuration management information. Alternatively, the apparatus N01 may contain a plurality types of configuration management information depending on the number of processes performed in the apparatus N01. The configuration management information is information used to associate virtual devices with physical devices as described above, thus it is possible to change the physical device which is actually used at the time of using a certain virtual device by rewriting the physical device defined in the configuration management information. In addition, the configuration management information is used to associate virtual devices with physical devices as described above, and thus the configuration management information is dissimilar to a device driver.

In the illustrated example, the configuration management information includes, for example, information as shown in Table 1 below. Each of the physical devices may be specified by location information on a network such as MAC address or IP address.

TABLE 1

| Virtual I/O devices | Physical I/O devices |
|---|---|
| VD011 | N03: PD031 |
| VD012 | N02: PD021 |
| VD013 | N01: PD011 |
| VD014 | N01: PD012 |

The above Table 1 shows an example of the configuration management information.

In the apparatus N02 and N03, each of the device virtualization layers VL02 and VL03 serves as an interface in the case where the physical devices PD021 and PD031 are used from the device virtualization layer VL01 of the apparatus N01 via a network. In addition, although not shown in the figure, there may be a case where the apparatus N02 and N03 are capable of executing a process in a substantially similar way to the apparatus N01. In this case, the device virtualization layers VL02 and VL03 may contain configuration management information in a substantially similar way to the device virtualization layer VL01, and may make a virtualization of local physical devices and remote physical devices. Further, the number of the apparatus is not limited to that illustrated in the example, and thus one or more apparatus may be used.

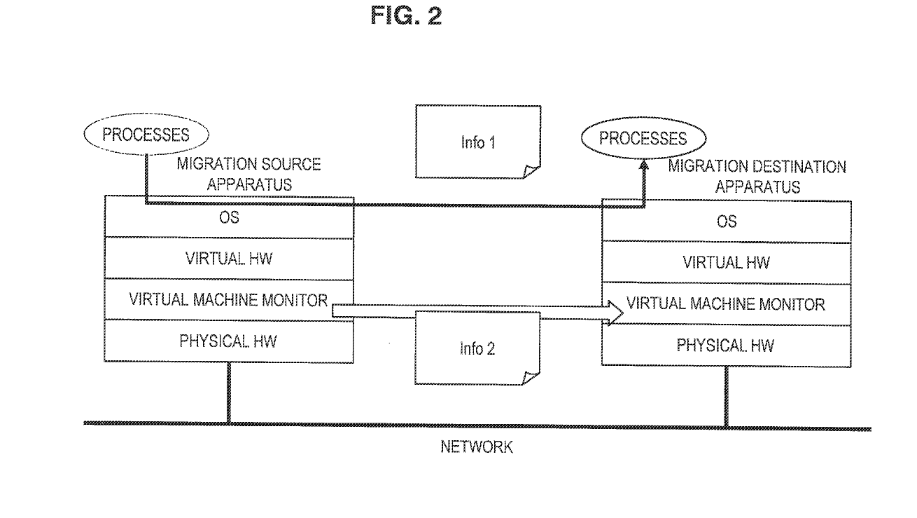

FIG. 2 is a diagram illustrating an overview of a process migration according to the first embodiment of the present disclosure. Referring to FIG. 2, an example is illustrated where a migration destination apparatus continuously executes a process that has been performed in a migration source apparatus by taking over from the migration source apparatus.

When the execution of the process to be migrated is stopped in the migration source apparatus, image information of the process (Info1) is created. This image information may include, for example, information that defines modules used in the process and information that indicates a running state of modules in the process. The image information is transmitted from the migration source apparatus to the migration destination apparatus via a network. The migration destination apparatus restarts the execution of the process based on the received image information.

On the other hand, configuration management information (Info2) is transmitted from the migration source apparatus to the migration destination apparatus. This configuration management information is used to manage corresponding relationships between the virtual devices and the physical devices as described above, and is included in, for example, a virtual machine monitor of the migration source apparatus. More specifically, the configuration management information contains location information of the physical devices corresponding to the virtual devices. Information that indicates a state of the virtual device may be transmitted together with the configuration management information. The migration destination apparatus can restart the execution of the process using the virtual devices in a similar way to when the process has been performed in the migration source device by reading the received configuration management information into the virtual machine monitor.

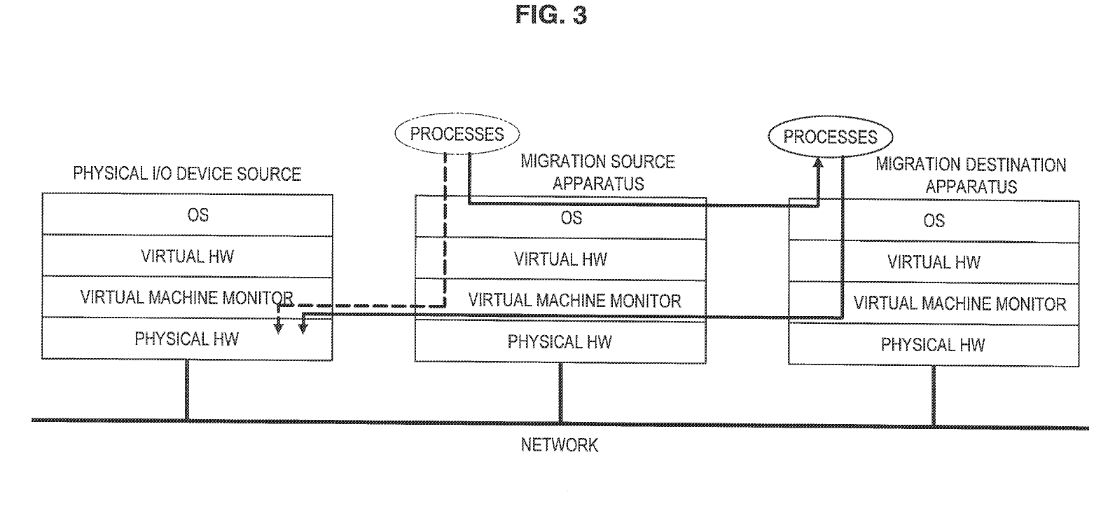

FIG. 3 is a diagram for explaining how to use devices after the migration of the process is completed according to the first embodiment of the present disclosure. An example of the case where configuration management information has not been rewritten is shown in FIG. 3.

In the illustrated example, the process being executed in a migration source apparatus remotely uses a physical hardware located in an external apparatus (physical I/O device source) through a virtual machine monitor (device virtualization layer). When the process is migrated to the migration destination apparatus, configuration management information is also transmitted to the migration destination apparatus, as described above. Thus, as shown, the process which is restarted after the migration is completed can continuously use the physical hardware located in the same external apparatus (physical I/O device source) through a virtual machine monitor (device virtualization layer) of the migration destination apparatus.

In this regard, in accordance with the embodiment, configuration management information is rewritten in the migration destination apparatus at the time of the migration of the process. The migration destination apparatus checks the status of the apparatus, for example, whether a physical device is available, a state of communication, a user's situation, and so on, and rewrites the configuration management information based on the results thereof. This rewriting makes it possible, for example, to change one physical device corresponding to a certain virtual device into another physical device. The process whose execution is restarted in the migration destination apparatus uses a physical device through a virtual device based on the rewritten configuration management information. Specifically, when the process uses the same virtual device as that used before the process is migrated, an actually used physical device may be a different physical device from that used before the process is migrated.

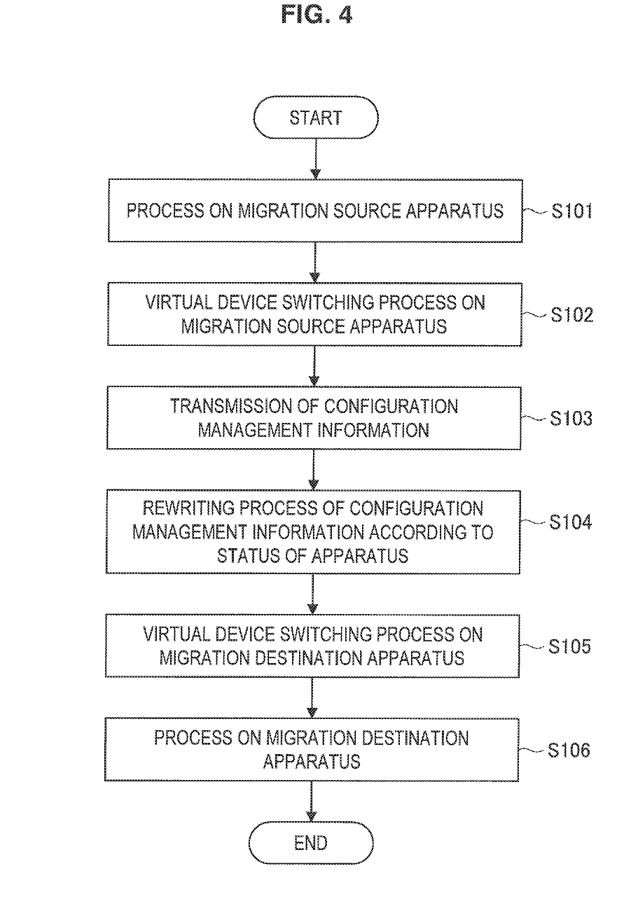

FIG. 4 is a flow chart illustrating an exemplary process of the process migration according to the first embodiment of the present disclosure.

A process for the process migration on a migration source apparatus is performed (step S101). The process in this step may include termination of process, generation of image information (a state of the process is saved), erasure of process, and transmission of image information to a migration destination apparatus.

A switching process of virtual devices is performed in the migration destination apparatus (step S102). The steps S102 and S101 are performed in random order. The process in this step S102 may include a process of preparing relevant information related to the virtual device to be provided to a migration destination apparatus. The relevant information may include configuration management information that indicates corresponding relationships between virtual and physical devices, and information that indicates a state of the virtual device.

Subsequently, the configuration management information is transmitted from the migration source apparatus to the migration destination apparatus (step S103). The transmitted configuration management information is configuration management information corresponding to the process to be migrated. If configuration management information is not prepared for each of the processes, then information obtained by copying common process management information for the process to be migrated is transmitted to the migration destination apparatus.

Next, the transmitted configuration management information is rewritten in the migration destination apparatus (step S014). In this embodiment, because the configuration management information is rewritten in the migration destination apparatus, information including the status of the migration destination apparatus, for example, whether a physical device is available, a state of communication, a user's situation, and so on may be obtained internally in the migration destination apparatus.

Next, a switching process of a virtual device is performed in the migration destination apparatus using the transmitted configuration management information (step S105). This process may include, for example, a process of defining a virtual device for the process to be migrated based on the transmitted configuration management information.

Next, a process for the process migration is performed in the migration destination apparatus (step S106). In this step, for example, the execution of the process may be restarted based on the image information received from the migration source apparatus. The process to be executed uses a physical device through the virtual device according to the definition performed in the step S105.

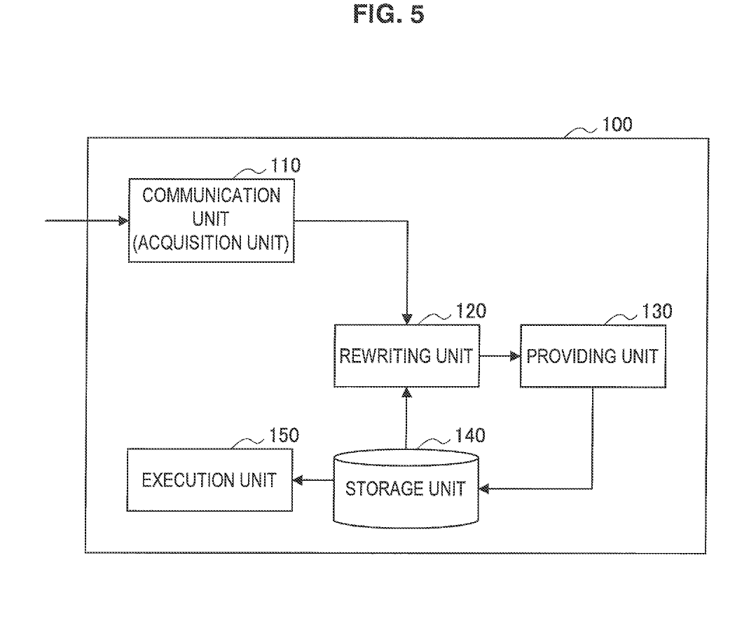

FIG. 5 is a schematic block diagram illustrating a functional configuration of the migration destination apparatus according to the first embodiment of the present disclosure. Referring to FIG. 5, the migration destination apparatus 100 includes a communication unit 110, a rewriting unit 120, a providing unit 130, a storage unit 140, and an execution unit 150. The migration destination apparatus may be implemented in, for example, hardware configuration of the information processing apparatus, as described later.

The communication unit 110 also serves as an acquisition unit for acquiring configuration management information from a migration source apparatus at the time of the execution of the process migration and for providing the acquired configuration management information to the rewriting unit 120. Further, the communication unit 110 may be configured to receive image information from the migration source apparatus. The image information is created at the time of the execution of the process migration. In addition, the communication unit 110 may be configured to receive various types of information from any other apparatus, which may be used to rewrite the configuration management information by the rewriting unit 120.

The rewriting unit 120 rewrites the configuration management information acquired by the communication unit 110 according to the status of an apparatus that will perform the process after the migration is completed, i.e. the migration destination apparatus 100. The rewriting unit 120 may rewrite the configuration management information based on information which is related to status of the migration destination apparatus 100 acquired from the storage unit 140 or the like. The rewriting unit 120 may be implemented in, for example, software using the CPU.

For example, if the physical device defined by the configuration management information is not available at the migration destination apparatus 100, then the rewriting unit 120 may rewrite the physical device defined by the configuration management information into any other physical device available at the migration destination apparatus 100. The rewriting unit 120 may acquire information related to an available physical device, for example, from the storage unit 140.

The determination as to whether the physical device is available may be done by, for example, whether or not the communication status between the migration destination apparatus 100 and the physical device meets predetermined criteria. The predetermined communication conditions may be, for example, whether a network bandwidth necessary to transmit and receive data between the physical device and the migration destination apparatus is reserved. By rewriting the configuration management information based on such a determination, it is possible to prevent the process from being difficult to execute in case of the physical device is unavailable because the communication conditions are changed after the migration of the process is completed.

Further, the determination as to whether the physical device is available may be done by, for example, whether or not the migration destination apparatus 100 is connectable to the physical device in terms of communication security. Because there may be cases where some apparatus are not connectable to an external apparatus via a network, the physical device that was connectable from a migration source apparatus may be not connectable from a migration destination apparatus 100. Thus, a physical device connectable from the migration destination apparatus 100 is selected by rewriting the configuration management information. This makes it possible to prevent the process from being difficult to execute in case of the physical device is not available because the security conditions are changed after the migration of the process is completed.

Moreover, for example, there may be the case where it is expected that the communication between the physical device defined by the configuration management information and the migration destination apparatus 100 is disconnected. In this case, the rewriting unit 120 rewrites the physical device defined by the configuration management information into a physical device in which the communication with the migration destination apparatus 100 is less likely to be disconnected, for example, a physical device located locally in the migration destination apparatus 100. The rewriting unit 120 may investigate the communication status of the migration destination apparatus 100, for example, via the communication unit 110. This rewriting makes it possible to prevent the process from being difficult to execute in case of the physical device is unavailable because the communication status is changed after the migration of the process is completed.

Furthermore, for example, when a compatible device with a level higher than the physical device defined by the configuration management information is available in the migration destination apparatus 100, the rewriting unit 120 may rewrite the physical device defined by the configuration management information into the higher-level compatible device. The rewriting unit 120 acquires information related to a physical device available at the migration destination apparatus 100, for example, from the storage unit 140. The higher-level compatible device may be a physical device which can implement more advanced features such as high-definition image display, high-quality audio output, and so on.

In addition, for example, the rewriting unit 120 may rewrite a physical device defined by the configuration management information according to processing capability of the migration destination apparatus 100. The rewriting unit 120 may acquire information related to the present or future processing capability of the migration destination apparatus 100, for example, from the storage unit 140. The rewriting unit 120 may rewrite a defined physical device, for example, according to amounts of available resource of the migration destination apparatus 100 (e.g., the processing capability and utilization of CPU, a memory capacity, available free space on memory). As an example, the rewriting unit 120 may select a physical device with the reduced load on CPU when CPU utilization of the migration destination apparatus 100 is high.

Further, for example, the rewriting unit 120 may rewrite a physical device defined by configuration management information according to a user's situation. As an example, the rewriting unit 120 may access to an external apparatus capable of recognizing a user's position in the room (the migration destination apparatus 100 may have such a function therein) through the providing unit 130, and select a speaker (physical device) optimal for the user's position. In addition, the rewriting unit 120 may acquire information which is set by the user from the storage unit 140, and select a physical device suitable for a user's preference based on the acquired information.

Moreover, for example, the rewriting unit 120 may rewrite a physical device defined by configuration management information into a dummy device. The dummy device is configured, for example, by emulating a normal physical device using software. In addition, the use of the dummy device may mean that a physical device is used with an ID (e.g., guest ID) different from an original user ID. For example, when a storage device such as HDD is used as a dummy device, a current directory on a file system may be changed to one different from the original. Thus, for example, in a case where the process to be migrated does not meet predetermined security criteria (more specifically, without having a certificate of server, without exchanging an authenticated key, and so on), resources accessible in the process can be limited upon restarting after the migration of the process is completed. Therefore, it is possible to reduce the damage that would be caused by an unauthorized process. When security of the process is verified, the rewriting unit 120 may rewrite configuration management information, thereby rewriting the dummy device into an authorized physical device.

The providing unit 130 provides the configuration management information rewritten by the rewriting unit 120 to the storage unit 140. In addition, the providing unit 130 provides the image information acquired by the communication unit 110 to the storage unit 140. The configuration management information and image information may be stored in the storage unit 140 without any modification. Alternatively, information previously stored in the storage unit 140 may be updated based on the configuration management information and image information. The providing unit 130 may be implemented in, for example, software using the CPU.

The storage unit 140 stores various types of information related to the execution of the process on the migration destination apparatus 100 persistently or temporarily. The storage unit 140 stores, for example, configuration management information or information corresponding to the configuration management information. The configuration management information provided from the providing unit 130 is reflected in the information stored in the storage unit 140. The storage unit 140 may be implemented by various storage media such as a RAM or ROM, a storage device, and a removable recording medium.

The execution unit 150 is configured to execute a process in the migration destination apparatus 100. The execution unit 150 executes a process, for example, using a virtual device according to the configuration management information (or information corresponding thereto) stored in the storage unit 140. In this case, a physical device which is associated with a virtual device referred by the execution unit 150 may be a device rewritten by the rewriting unit 120. The execution unit 150 may be implemented in, for example, software using the CPU.

Furthermore, it should be noted that the functional configuration of the migration source apparatus could be configured substantially similar to that of the migration destination apparatus 100. However, in the present embodiment, application-defined information is rewritten in the migration destination apparatus, thus the migration source apparatus may not necessarily include the functional configuration of the rewriting unit 120.

### 2. SECOND EMBODIMENT

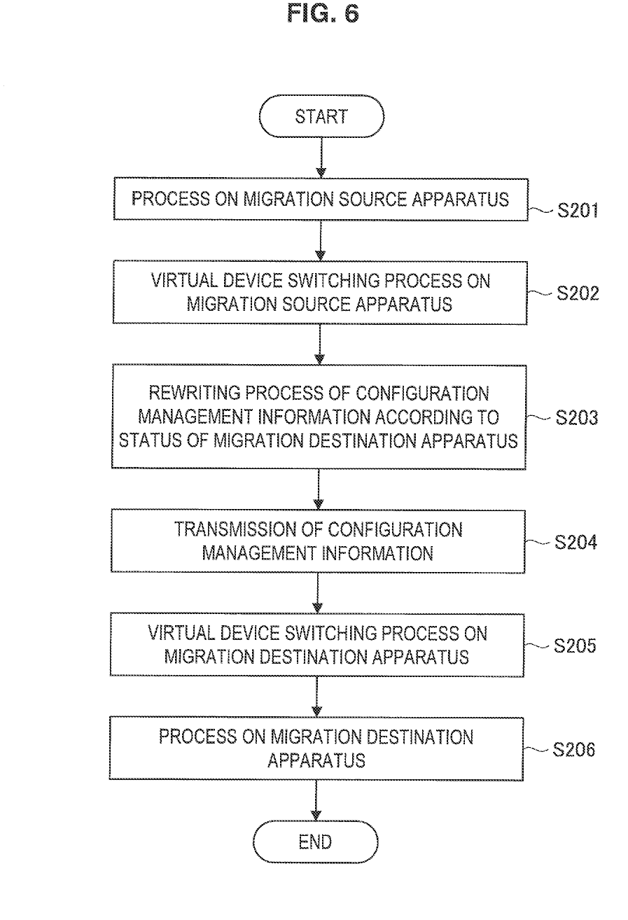

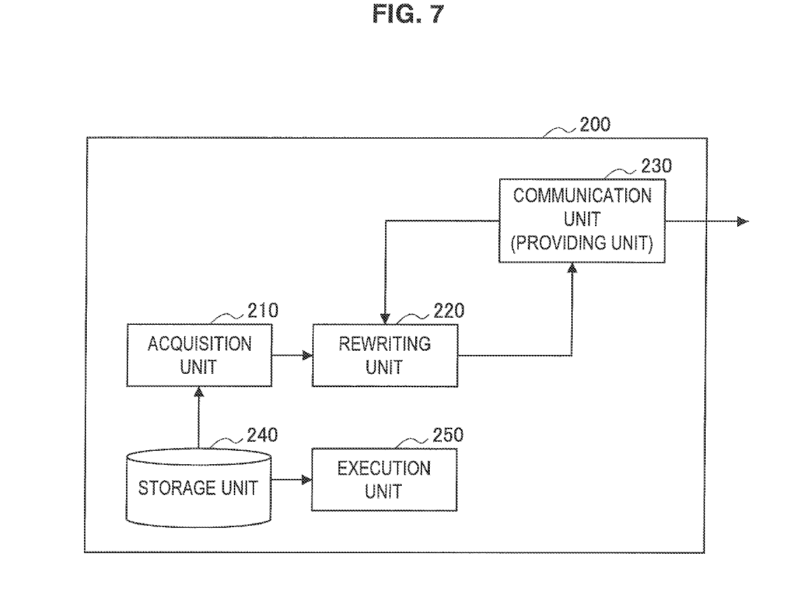

A second embodiment of the present disclosure will now be described with reference to FIG. 6 and FIG. 7. Note that, how to use devices at the time of the execution of a process, overview of the process migration, and how to use devices after the migration of a process are substantially similar to those of the first embodiment, and thus the detailed explanation thereof will be omitted here.

FIG. 6 is a flow chart illustrating an exemplary process of a process migration according to the second embodiment of the present disclosure. Note that, among the illustrated process flows, steps S201, S202, S205, and S206 are substantially similar to the steps S101, S102, S105, and S106, respectively, described referring to the FIG. 4, and thus the detailed explanation thereof will be omitted here.

Following the step S202, configuration management information is rewritten in the migration source apparatus according to the status of the migration destination apparatus (step S203). More specifically, in this embodiment, the configuration management information is rewritten before the configuration management information is transmitted from the migration source apparatus to the migration destination apparatus. The migration source apparatus checks the status of the migration destination apparatus, for example, whether a physical device is available, a state of communication, a user's situation, and so on, via a network, and rewrites the configuration management information based on the results thereof. The configuration management information to be rewritten is configuration management information corresponding to the process to be migrated. If the configuration management information is not prepared for each of the processes, then information obtained by copying common process management information for the process to be migrated becomes information to be rewritten.

Next, the configuration management information is transmitted from the migration source apparatus to the migration destination apparatus (step S204). In this step, the configuration management information to be transmitted is information rewritten in the step S203. In the processes subsequent to the step S205, the rewritten configuration management information which is transmitted from the step S204 is used.

FIG. 7 is a schematic block diagram illustrating a functional configuration of the migration source apparatus according to the second embodiment of the present disclosure. Referring to FIG. 7, a migration source apparatus 200 includes an acquisition unit 210, a rewriting unit 220, a communication unit 230, a storage unit 240, and an execution unit 250. The migration source apparatus 200 may be implemented in, for example, hardware configuration of the information processing apparatus, as described later.

The acquisition unit 210 acquires configuration management information at the time of the migration of a process and provides the configuration management information to the rewriting unit 220. The configuration management information may be acquired from the storage unit 240. Alternatively, the configuration management information may be generated by the acquisition unit 210 based on information stored in the storage unit 240. The acquisition unit 210 may be implemented in, for example, software using the CPU.

The rewriting unit 220 rewrites the configuration management information acquired by the acquisition unit 210 at the time of the migration of the process, according to the status of an apparatus that will execute the process after the migration is completed, i.e. a migration destination apparatus. The rewriting unit 220 may rewrite the configuration management information based on information related to the status of the migration destination apparatus acquired through the communication unit 230. The rewriting unit 220 may be implemented in, for example, software using the CPU. In addition, a specific example of the rewriting performed by the rewriting unit 220 may be substantially similar to that of the first embodiment described above.

The communication unit 230 may serve as a providing unit for providing the configuration management information rewritten by the rewriting unit 220 to an apparatus that will execute the process after the migration is completed, i.e. a migration destination apparatus. In addition, the communication unit 230 provides image information created at the time of the migration of the process to the migration destination apparatus. Further, the communication unit 230 may receive various types of information from the migration destination apparatus or the like. The various types of information may be used to rewrite the configuration management information by the rewriting unit 220.

The storage unit 240 stores, persistently or temporarily, various types of information related to the execution of the process on the migration source apparatus 200. The storage unit 240 stores, for example, configuration management information or information corresponding to the configuration management information. The storage unit 240 may be implemented by various storage media such as a RAM or ROM, a storage device, and a removable recording medium.

The execution unit 250 is configured to execute a process in the migration source apparatus 200. The execution unit 250 executes a process using a virtual device according to the configuration management information (or information corresponding thereto) stored in the storage unit 240. The execution unit 250 may be implemented in, for example, software using the CPU.

Moreover, it should be noted that the functional configuration of the migration destination apparatus could be configured substantially similar to that of the migration source apparatus 200 described above. However, in the present embodiment, application-defined information is rewritten in the migration source apparatus, thus the migration destination apparatus may not necessarily include the functional configuration of the rewriting unit 220.

### 3. SPECIFIC EXAMPLE OF REWRITING

Next, a specific example of rewriting the configuration management information according to the embodiment of the present disclosure will be described. The example described below may be applied to the first and second embodiments of the present disclosure described above.

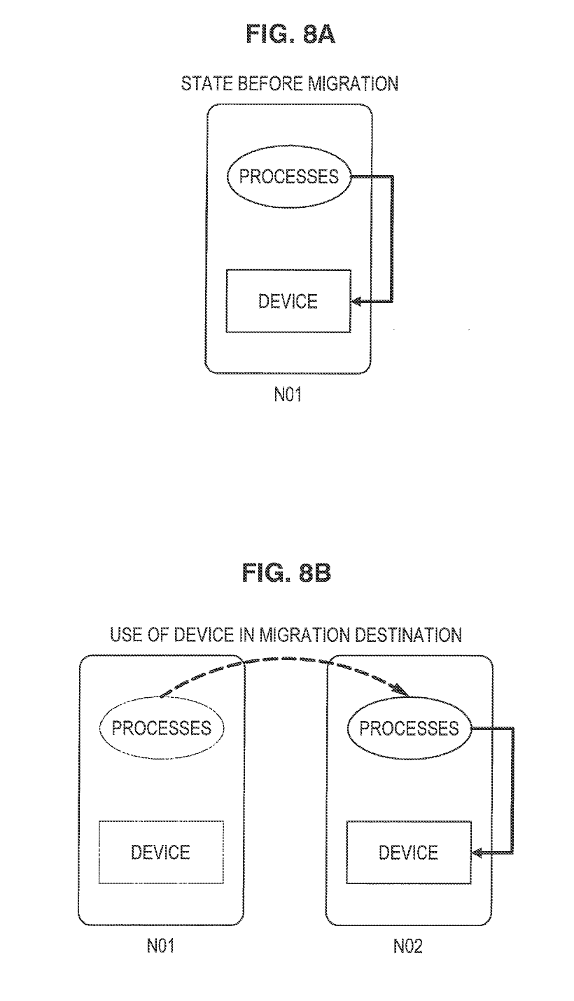

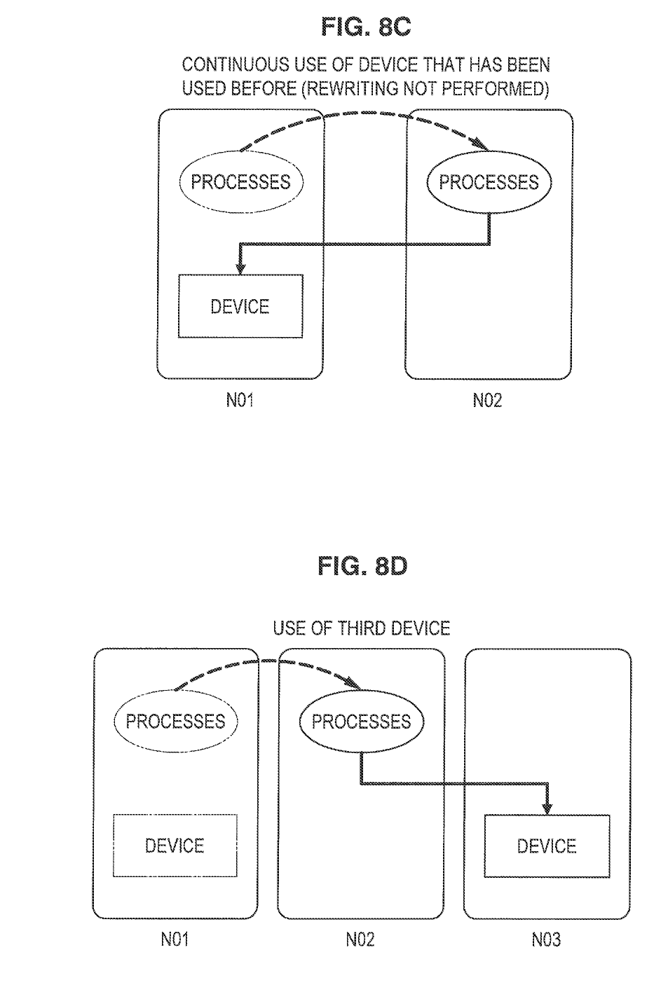

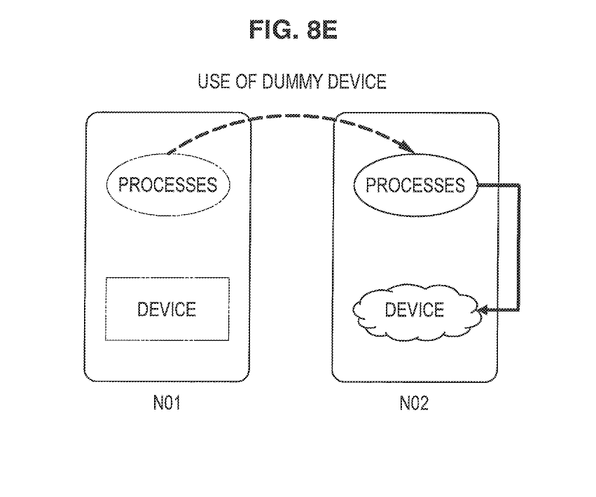

An example of the case where a physical device used through a virtual device before the migration is performed is the device located locally in the migration source apparatus will be described with reference to FIGS. 8A to 8E.

FIG. 8A is a diagram illustrating a state before the migration is performed. The process being executed on an apparatus N01 makes use of a physical device located locally in the apparatus N01 through a virtual device.

FIG. 8B is a diagram illustrating an example of rewriting configuration management information to make use of a device located locally in the migration destination apparatus at the time of the migration of the process. In this case, a physical device to be used through a virtual device in the process is changed to a device located locally in the apparatus N01, as a subject that will execute the process is changed from the apparatus N01 to an apparatus N02. The rewriting of the configuration management information is effective in a case where communication environment of the apparatus N02 is not stable and thus a remote physical device is likely to be no longer available due to disconnection of communication. In addition, such a rewriting is also effective in a case where the access of the apparatus N02 to a remote physical device is not permitted.

FIG. 8C is a diagram illustrating a case where the configuration management information is not rewritten at the time of the migration of the process. In some cases, the configuration management information may not be rewritten at the time of the migration of the process depending on the results obtained from the determination of whether there is such a rewriting. In this case, even when a subject that will execute the process is changed from the apparatus N10 to the apparatus N02, a physical device associated with the virtual device is the physical device which has been located in the apparatus N01. Thus, the apparatus N02 makes use of this device located remotely from the apparatus N02 according to the configuration management information. In this case, user can use applications or the like provided in the process without considering the process migration, because the same physical device is continuously used even after the process is migrated.

FIG. 8D is a diagram illustrating an example where the configuration management information is rewritten at the time of the migration of the process so that a device located in an apparatus different from the migration source apparatus or migration destination apparatus may be used. In this example, when a subject that will execute the process is changed from the apparatus N01 to the apparatus N02, a physical device used through a virtual device in the process is changed to a device located in an apparatus N03. Such a rewriting is effective in a case where communication environment between the apparatus N02 and the apparatus N03 is relatively more stable than between the apparatus N01 and the apparatus N02.

FIG. 8E is a diagram illustrating an example of rewriting configuration management information to make use of a dummy device at the time of the migration of the process. In this example, when a subject that will execute the process is changed from the apparatus N01 to the apparatus N02, a physical device to be used through a virtual device in the process is changed to, for example, a dummy device prepared in the apparatus N02. This rewriting is effective when the apparatus N02 contains personal information or the like of the user and it is not preferable for an unauthorized process to freely access to resources of the apparatus N02. In addition, the dummy device may be prepared as an apparatus such as the apparatus N01 or N03 other than the apparatus N02.

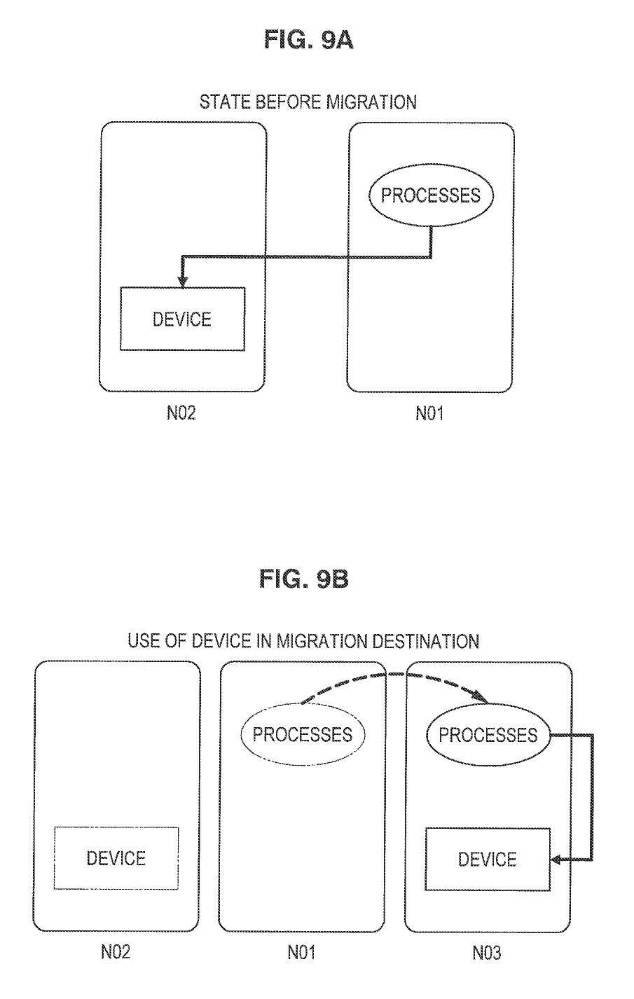

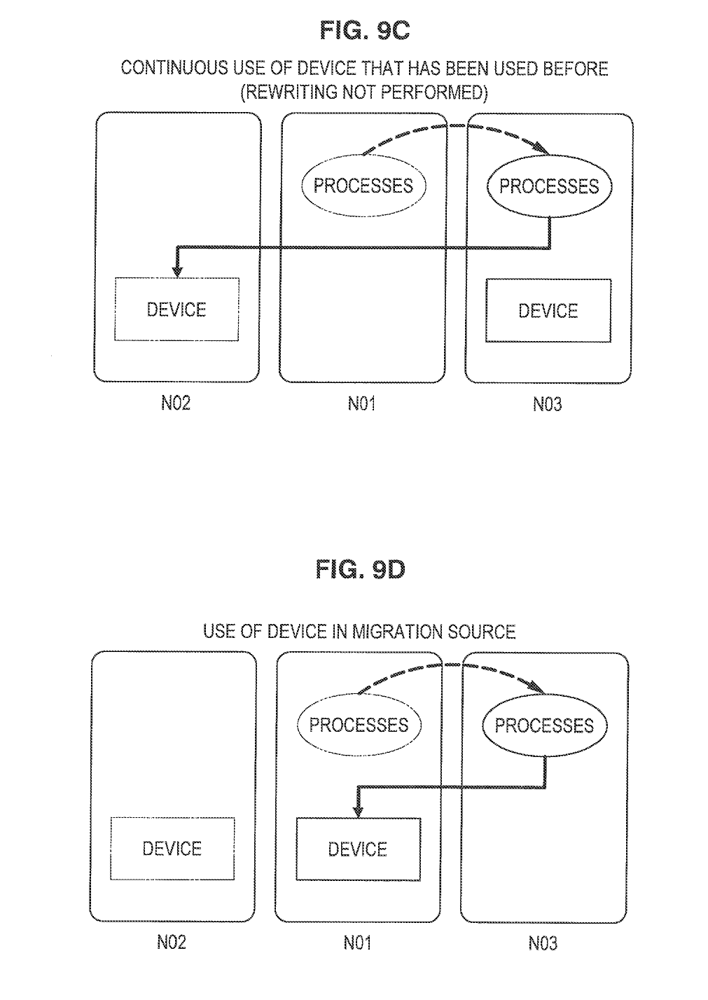

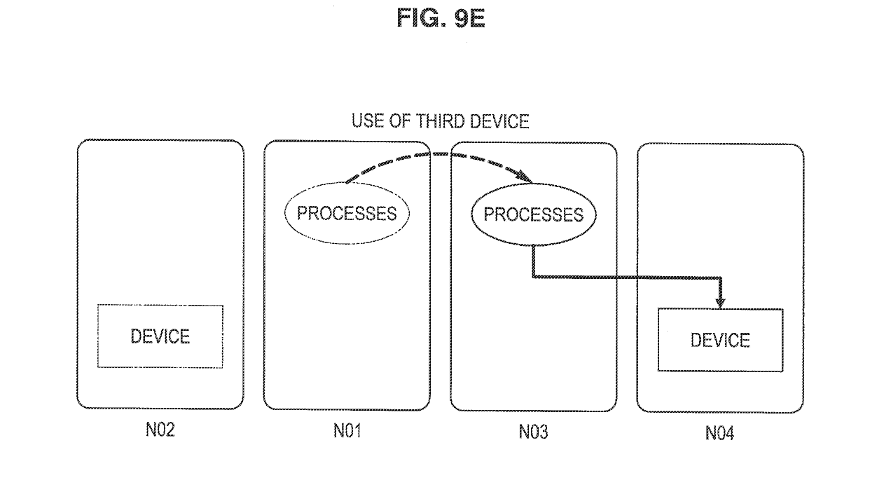

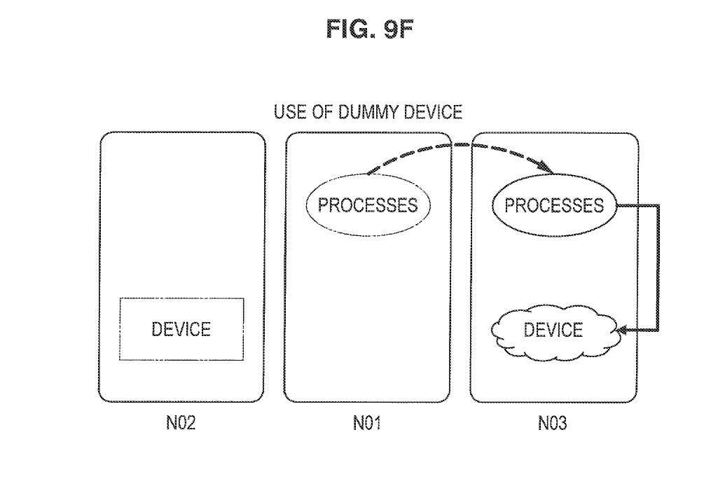

Next, an example of a case where a physical device used through a virtual device before the migration is a device located remotely from a migration source apparatus will now be described with reference to FIGS. 9A to 9F.

FIG. 9A is a diagram illustrating a state before the migration. A process being executed in the apparatus N01 makes use of a physical device located in the apparatus N02 through a virtual device.

FIG. 9B is a diagram illustrating an example of rewriting configuration management information to make use of a device located locally in the migration destination apparatus at the time of the migration of the process. In this example, a physical device to be used through a virtual device in the process is changed to a device located locally in the apparatus N03, as a subject that will execute the process is changed from the apparatus N01 to the apparatus N03. This rewriting of configuration management information is effective in the case where communication environment of the apparatus N03 is not stable and a remote physical device is likely to be no longer available due to disconnection of communication. In addition, the rewriting is effective in a case where the access of the apparatus N03 to the remote physical device is not permitted.

FIG. 9C is a diagram illustrating a case where configuration management information is not rewritten at the time of the migration of the process. In some cases, the configuration management information may not be rewritten at the time of the migration of the process depending on the results obtained from the determination of whether there is such a rewriting. In this case, even when a subject that will execute the process is changed from the apparatus N10 to the apparatus N03, a physical device associated with a virtual device is the physical device which has been located in the apparatus N02. Thus, the apparatus N03 makes use of the physical device located remotely from the apparatus N03 in a similar way to the apparatus N01. In this case, user can make use of applications or the like provided in the process without considering the process migration, because the same physical device is continuously used even after the process is migrated.

FIG. 9D is a diagram illustrating an example of rewriting configuration management information to make use of a device located in a migration source apparatus at the time of the migration of the process. In this example, a physical device to be used through a virtual device in the process is changed to a device located in the apparatus N01, as a subject that will execute the process is changed from the apparatus N01 to the apparatus N03. This rewriting of the configuration management information is effective in the case where the apparatus N01 is authorized by the apparatus N03 but the apparatus N02 is not authorized by the apparatus N03.

FIG. 9E is a diagram illustrating an example of rewriting configuration management information at the time of the migration of a process to make use of a remotely located device different from the device which has been used before the migration. In this example, when a subject that will execute the process is changed from the apparatus N01 to the apparatus N03, a physical device used through a virtual device in the process is changed to a device located in an apparatus N04. Such a rewriting is effective in a case where communication environment between the apparatus N03 and the apparatus N04 is relatively more stable than between the apparatus N02 and the apparatus N03.

FIG. 9F is a diagram illustrating an example of rewriting configuration management information to make use of a dummy device when a process is migrated. In this example, when a subject that will execute the process is changed from the apparatus N01 to the apparatus N03, a physical device to be used through a virtual device in the process is changed to, for example, a dummy device prepared in the apparatus N03. This rewriting is effective when the apparatus N03 contains the personal information or the like of the user and it is not preferable for an unauthorized process to freely access to resources of the apparatus N03. In addition, the dummy device may be prepared in an apparatus such as the apparatus N01, N02, or N04 other than the apparatus N03.

### 4. HARDWARE CONFIGURATION

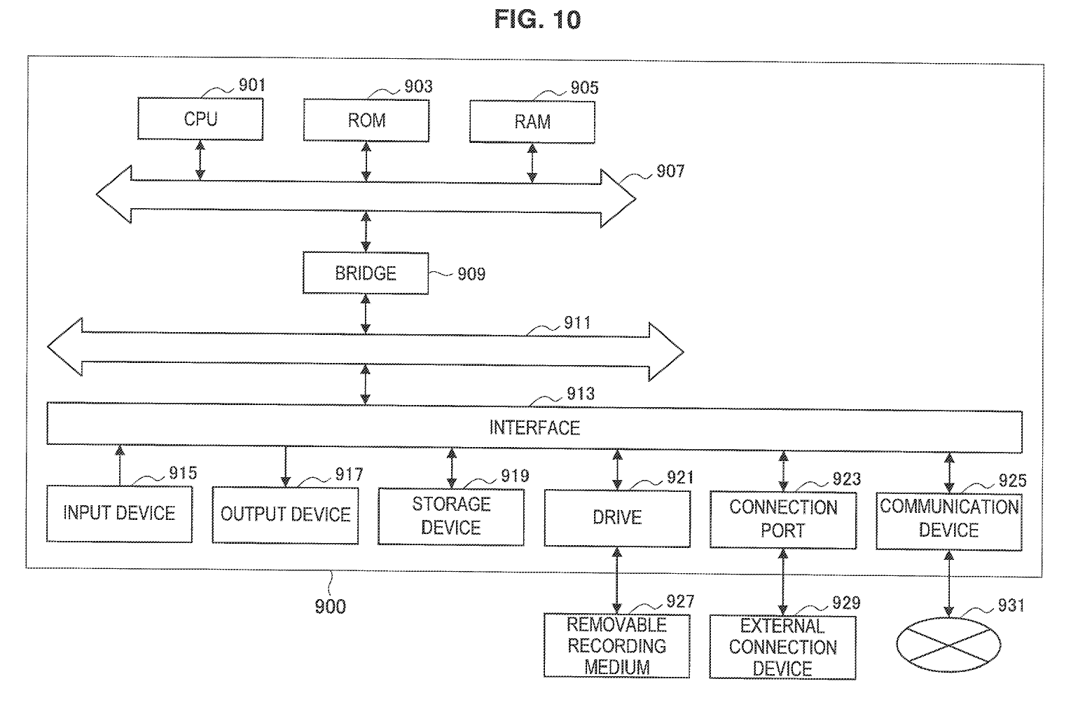

Next, referring to FIG. 10, a hardware configuration of the information processing apparatus according to the embodiment of the present disclosure will be described. FIG. 10 is a block diagram for explaining the hardware configuration of the information processing apparatus. An information processing apparatus 900 illustrated in FIG. 10 may implement, for example, the migration source apparatus 100 and the migration destination apparatus 200 as described in the above-mentioned embodiments.

The information processing apparatus 900 includes a CPU (Central Processing Unit) 901, a ROM (Read Only Memory) 903, and a RAM (Random Access Memory) 905. In addition, the information processing apparatus 900 may include a host bus 907, a bridge 909, an external bus 911, an interface 913, an input device 915, an output device 917, a storage device 919, a drive 921, a connection port 923, and a communication device 925. The information processing apparatus 900 may include a processing circuit such as a DSP (Digital Signal Processor), alternatively or in addition to the CPU 901.

The CPU 901 serves as an operation processor and a controller, and controls all or some operations in the information processing apparatus 900 in accordance with various programs recorded in the ROM 903, the RAM 905, the storage device 919 or a removable recording medium 927. The ROM 903 stores programs and operation parameters which are used by the CPU 901. The RAM 905 primarily stores program which are used in the execution of the CPU 901 and parameters which is appropriately modified in the execution. The CPU 901, ROM 903, and RAM 905 are connected to each other by the host bus 907 configured to include an internal bus such as a CPU bus. In addition, the host bus 907 is connected to the external bus 911 such as a PCI (Peripheral Component Interconnect/Interface) bus via the bridge 909.

The input device 915 may be a device which is operated by a user, such as a mouse, a keyboard, a touch panel, buttons, switches and a lever. The input device 915 may be, for example, a remote control unit using infrared light or other radio waves, or may be an external connection device 929 such as a portable phone operable in response to the operation of the information processing apparatus 900. Furthermore, the input device 915 includes an input control circuit which generates an input signal on the basis of the information which is input by a user and outputs the input signal to the CPU 901. By operating the input device 915, a user can input various types of data to the information processing apparatus 900 or issue instructions for causing the information processing apparatus 900 to perform a processing operation.

The output device 917 includes a device capable of visually or audibly notifying the user of acquired information. The output device 917 may include a display device such as LCD (Liquid Crystal Display), PDP (Plasma Display Panel), and organic EL (Electro-Luminescence) displays, an audio output device such as speaker and headphone, and a peripheral device such as printer. The output device 917 may output the results obtained from the process of the information processing apparatus 900 in a form of a video such as text or image, and an audio such as voice or sound.

The storage device 919 is a device for data storage which is configured as an example of a storage unit of the information processing apparatus 900. The storage device 919 includes, for example, a magnetic storage device such as HDD (Hard Disk Drive), a semiconductor storage device, an optical storage device, or a magneto-optical storage device. The storage device 919 stores programs to be executed by the CPU 901, various data, and data obtained from the outside.

The drive 921 is a reader/writer for the removable recording medium 927 such as a magnetic disk, an optical disk, a magneto-optical disk, or a semiconductor memory, and is embedded in the information processing apparatus 900 or attached externally thereto. The drive 921 reads information recorded in the removable recording medium 927 attached thereto, and outputs the read information to the RAM 905. Further, the drive 921 can write in the removable recording medium 927 attached thereto.

The connection port 923 is a port used to directly connect devices to the information processing apparatus 900. The connection port 923 may include a USB (Universal Serial Bus) port, an IEEE1394 port, and a SCSI (Small Computer System Interface) port. The connection port 923 may further include an RS-232C port, an optical audio terminal, an HDMI (High-Definition Multimedia Interface) port, and so on. The connection of the external connection device 929 to the connection port 923 makes it possible to exchange various data between the information processing apparatus 900 and the external connection device 929.

The communication device 925 is, for example, a communication interface including a communication device or the like for connection to a communication network 931. The communication device 925 may be, for example, a communication card for a wired or wireless LAN (Local Area Network), Bluetooth (registered trademark), WUSB (Wireless USB) or the like. In addition, the communication device 925 may be a router for optical communication, a router for ADSL (Asymmetric Digital Subscriber Line), a modem for various kinds of communications, or the like. The communication device 925 can transmit and receive signals to and from, for example, the Internet or other communication devices based on a predetermined protocol such as TCP/IP. In addition, the communication network 931 connected to the communication device 925 may be a network or the like connected in a wired or wireless manner, and may be, for example, the Internet, a home LAN, infrared communication, radio wave communication, satellite communication, or the like.

As above, the exemplary hardware configuration of the information processing apparatus 900 has been described. Each of the above-described constituent elements may be configured using general-purpose members, or may be configured by hardware specialized to the function of each constituent element. Therefore, a hardware configuration to be used may be appropriately modified according to the technical level at the time of implementing the embodiment.

### 5. CONCLUSION

In accordance with the embodiments described above, configuration management information is rewritten at the time of the processing migration, and a module to be used in the process is updated. The configuration management information may be rewritten in a migration source apparatus or may be rewritten in a migration destination apparatus, as described in embodiments above. Alternatively, the configuration management information may be transmitted to an apparatus such as a server different from the migration source apparatus or migration destination apparatus, and may be rewritten in that apparatus.

The status of an apparatus for executing a process is different before and after the migration of the process, and thus configurations of an optimal hardware device used in the process may be varied. Therefore, by rewriting a physical device to be defined in the configuration management information at the time of the processing migration, it is possible to use an optimal physical device at all times, both before and after the migration of the process.

In the embodiments described above, the example of rewriting configuration management information at the time of the processing migration has been described. However, the embodiments of the present disclosure are applicable even when the process migration is not necessarily performed. For example, when a process of unauthorized application will be newly executed, the execution may be started by rewriting the configuration management information which is originally assigned in the process and by using a dummy device.

The embodiments of the present disclosure, as described above, may include the information processing apparatus, information processing system, information processing method, program for causing a computer to function as the information processing apparatus, and recording medium which records therein the program.

Additionally, the present technology may also be configured as below.

(1) An information processing apparatus including:

an acquisition unit for acquiring configuration management information that defines a physical device used in a process;

a rewriting unit for rewriting the configuration management information in accordance with a status of an apparatus that executes the process; and

a providing unit for providing the rewritten configuration management information to an apparatus that executes the process.

(2) The information processing apparatus according to (1), wherein the configuration management information is transmitted and received between the information processing apparatus and an external apparatus in accordance with an alternation of a subject that executes the process, and

wherein the rewriting unit rewrites the configuration management information in accordance with a status of a migration destination apparatus, the migration destination apparatus being one of the information processing apparatus or the external apparatus that newly becomes a subject executing the process.

(3) The information processing apparatus according to (2), wherein, when the physical device defined by the configuration management information is not available to the migration destination apparatus, the rewriting unit rewrites the physical device into another physical device available to the migration destination apparatus.

(4) The information processing apparatus according to (3), wherein, when communication between the migration destination apparatus and the physical device is not permitted in terms of security of the migration destination apparatus, the rewriting unit rewrites the physical device into another physical device in which communication with the migration destination apparatus is permitted in terms of security of the migration destination apparatus.

(5) The information processing apparatus according to (3) or (4), wherein, when a communication condition between the migration destination apparatus and the physical device does not meet a predetermined criterion, the rewriting unit rewrites the physical device into another physical device in which a communication condition between the another physical device and the migration destination apparatus meets the predetermined criterion.

(6) The information processing apparatus according to any one of (2) to (5), wherein, when communication between the migration destination apparatus and the physical device defined by the configuration management information is expected to be disconnected, the rewriting unit rewrites the physical device into another physical device in which communication is less likely to be disconnected.

(7) The information processing apparatus according to any one of (2) to (6), wherein, when a physical device having backward compatibility with the physical device defined by the configuration management information is available to the migration destination apparatus, the rewriting unit rewrites the physical device into the physical device having backward compatibility.

(8) The information processing apparatus according to any one of (2) to (7), wherein the rewriting unit rewrites the physical device defined by the configuration management information into another physical device suitable for a processing capability of the migration destination apparatus.

(9) The information processing apparatus according to (8), wherein the rewriting unit rewrites the physical device into another physical device that is suitable for a processing capability of the migration destination apparatus during transmission or reception, or suitable for a processing capability expected after the transmission or reception.

(10) The information processing apparatus according to any one of (2) to (9), wherein the rewriting unit rewrites the physical device defined by the configuration management information into another physical device that is suitable for a status of a user of the migration destination apparatus.

(11) The information processing apparatus according to any one of (2) to (10),

wherein the acquisition unit receives the configuration management information from the external apparatus,

wherein the rewriting unit rewrites the configuration management information in accordance with a status of the information processing apparatus, and

wherein the providing unit internally provides the rewritten configuration management information.

(12) The information processing apparatus according to any one of (2) to (10),

wherein the acquisition unit internally acquires the configuration management information and receives information indicative of a status of the external apparatus from the external apparatus,

wherein the rewriting unit rewrites the configuration management information in accordance with the status of the external apparatus, and

wherein the providing unit transmits the rewritten configuration management information to the external apparatus.

(13) The information processing apparatus according to any one of (1) to (12), wherein, when the process does not meet a predetermined security criterion, the rewriting unit rewrites the physical device defined by the configuration management information into a dummy physical device.

(14) The information processing apparatus according to (13), wherein, when security of the process is verified, the rewriting unit rewrites the dummy physical device into an authorized physical device.

(15) An information processing method including:

acquiring configuration management information which defines a physical device used in a process;

rewriting the configuration management information in accordance with a status of an apparatus that executes the process; and

providing the rewritten configuration management information to an apparatus that executes the process.

(16) A program for causing a computer to execute the functions of:

acquiring configuration management information which defines a physical device used in a process;

rewriting the configuration management information in accordance with a status of an apparatus that executes the process; and

providing the rewritten configuration management information to an apparatus that executes the process.

(17) A computer-implemented information processing method, comprising:

rewriting, based on a status of a first apparatus designated to execute a process, configuration management information that defines one or more relationships between one or more virtual devices and one or more physical devices; and

providing the rewritten configuration management information to the first apparatus.

(18) The computer-implemented information processing method of (17), further comprising:

migrating the process from a second apparatus to the first apparatus.

(19) The computer-implemented information processing method of (18), wherein:

rewriting the configuration management information is performed by the first apparatus.

(20) The computer-implemented information processing method of (19), further comprising:

before migrating the process from the second apparatus to the first apparatus, executing the process on the second apparatus using a physical device of the second apparatus.

(21) The computer-implemented information processing method of (20), further comprising:

after migrating the process from the second apparatus to the first apparatus, executing the process on the first apparatus using a physical device of the first apparatus.

(22) The computer-implemented information processing method of (20), further comprising:

after migrating the process from the second apparatus to the first apparatus, executing the process on the first apparatus using a physical device of a third apparatus different from the first apparatus and the second apparatus.

(23) The computer-implemented information processing method of (20), further comprising:

after migrating the process from the second apparatus to the first apparatus, executing the process on the first apparatus using a dummy device of the first apparatus.

(24) The computer-implemented information processing method of (18), wherein:

rewriting the configuration management information is performed by the second apparatus.

(25) The computer-implemented information processing method of (24), further comprising:

before migrating the process from the second apparatus to the first apparatus, executing the process on the second apparatus using a physical device located in a third apparatus.

(26) The computer-implemented information processing method of (25), further comprising:

after migrating the process from the second apparatus to the first apparatus, executing the process on the first apparatus using a physical device located in the second apparatus.

(27) The computer-implemented information processing method of (25), further comprising:

after migrating the process from the second apparatus to the first apparatus, executing the process on the first apparatus using a physical device located in a fourth apparatus.

(28) The computer-implemented information processing method of (26), further comprising:

after migrating the process from the second apparatus to the first apparatus, executing the process on the first apparatus using a dummy device of the third apparatus.

(29) The computer-implemented information processing method of (17), wherein:

the status comprises at least one processing capability of the first apparatus.

(30) The computer-implemented information processing method of (29), wherein:

the at least one processing capability of the first apparatus indicates that the first apparatus has more processing capability than the second apparatus.

(31) The computer-implemented information processing method of claim (17), wherein:

the status comprises at least one property of a user of the first apparatus.

(32) The computer-implemented information processing method of (31), wherein:

the at least one property of the user comprises the user's location with respect to the first apparatus.

(33) The computer-implemented information processing method of (17), wherein:

the status comprises at least one property of a communication environment of the first apparatus.

(34) At least one non-transitory computer-readable storage medium comprising computer-executable instructions that, when executed by at least one processor, perform an information processing method, the method comprising:

rewriting, based on a status of an apparatus designated to execute a process, configuration management information that defines one or more relationships between one or more virtual devices and one or more physical devices; and

providing the rewritten configuration management information to the apparatus.

(35) An information processing apparatus, comprising:

a rewriting device configured to rewrite, based on a status of the information processing apparatus, configuration management information that defines one or more relationships between one or more virtual devices and one or more physical devices;

a storage device configured to store the rewritten configuration management information; and

a providing device configured to provide the rewritten configuration management information to the storage device.

(36) An information processing apparatus, comprising:

a rewriting device configured to rewrite, based on a status of a first apparatus designated to execute a process, configuration management information that defines one or more relationships between one or more virtual devices and one or more physical devices; and

a communication device configured to:

receive the status from the first apparatus; and

provide the rewritten configuration management information to the first apparatus.

Having thus described several aspects of at least one embodiment of this invention, it should be appreciated to those skilled in the art that various alterations, modifications, combinations and improvements will readily occur to those skilled in the art. Such alterations, modifications, combinations and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A computer-implemented information processing method, comprising:
rewriting, based on a status of a first apparatus designated to execute a process, configuration management information that defines one or more relationships between one or more virtual devices and one or more physical devices; and
providing the rewritten configuration management information to the first apparatus.

2. The computer-implemented information processing method of claim 1, further comprising:
migrating the process from a second apparatus to the first apparatus.

3. The computer-implemented information processing method of claim 2, wherein:
rewriting the configuration management information is performed by the first apparatus.

4. The computer-implemented information processing method of claim 3, further comprising:
before migrating the process from the second apparatus to the first apparatus, executing the process on the second apparatus using a physical device of the second apparatus.

5. The computer-implemented information processing method of claim 4, further comprising:
after migrating the process from the second apparatus to the first apparatus, executing the process on the first apparatus using a physical device of the first apparatus.

6. The computer-implemented information processing method of claim 4, further comprising:
after migrating the process from the second apparatus to the first apparatus, executing the process on the first apparatus using a physical device of a third apparatus different from the first apparatus and the second apparatus.

7. The computer-implemented information processing method of claim 4, further comprising:
after migrating the process from the second apparatus to the first apparatus, executing the process on the first apparatus using a dummy device of the first apparatus.

8. The computer-implemented information processing method of claim 2, wherein:
rewriting the configuration management information is performed by the second apparatus.

9. The computer-implemented information processing method of claim 8, further comprising:
before migrating the process from the second apparatus to the first apparatus, executing the process on the second apparatus using a physical device located in a third apparatus.

10. The computer-implemented information processing method of claim 9, further comprising:
after migrating the process from the second apparatus to the first apparatus, executing the process on the first apparatus using a physical device located in the second apparatus.

11. The computer-implemented information processing method of claim 9, further comprising:
after migrating the process from the second apparatus to the first apparatus, executing the process on the first apparatus using a physical device located in a fourth apparatus.

12. The computer-implemented information processing method of claim 9, further comprising:
after migrating the process from the second apparatus to the first apparatus, executing the process on the first apparatus using a dummy device of the third apparatus.

13. The computer-implemented information processing method of claim 1, wherein:
the status comprises at least one processing capability of the first apparatus.

14. The computer-implemented information processing method of claim 13, wherein:
the at least one processing capability of the first apparatus indicates that the first apparatus has more processing capability than the second apparatus.

15. The computer-implemented information processing method of claim 1, wherein:
the status comprises at least one property of a user of the first apparatus.

16. The computer-implemented information processing method of claim 15, wherein:
the at least one property of the user comprises the user's location with respect to the first apparatus.

17. The computer-implemented information processing method of claim 1, wherein:
the status comprises at least one property of a communication environment of the first apparatus.

18. At least one non-transitory computer-readable storage medium comprising computer-executable instructions that, when executed by at least one processor, perform an information processing method, the method comprising:
rewriting, based on a status of an apparatus designated to execute a process, configuration management information that defines one or more relationships between one or more virtual devices and one or more physical devices; and
providing the rewritten configuration management information to the apparatus.

19. An information processing apparatus, comprising:
a rewriting device configured to rewrite, based on a status of the information processing apparatus, configuration management information that defines one or more relationships between one or more virtual devices and one or more physical devices;
a storage device configured to store the rewritten configuration management information; and
a providing device configured to provide the rewritten configuration management information to the storage device.

20. An information processing apparatus, comprising:
a rewriting device configured to rewrite, based on a status of a first apparatus designated to execute a process, configuration management information that defines one or more relationships between one or more virtual devices and one or more physical devices; and
a communication device configured to:
receive the status from the first apparatus; and
provide the rewritten configuration management information to the first apparatus.
